(19) United States
(12) Patent Application Publication
(10) Pub. No.: US 2009/0322489 A1
(43) Pub. Date: Dec. 31, 2009

(54) MACHINE VISION RFID EXCITER TRIGGERING SYSTEM

(76) Inventors: Christopher Jones, Pacific Palisades, CA (US); Michael Smith, Santa Monica, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/423,668

(22) Filed: Apr. 14, 2009

Related U.S. Application Data
(60) Provisional application No. 61/044,893, filed on Apr. 14, 2008.

(51) Int. Cl. H04Q 5/22; G06K 9/00

(52) U.S. Cl. 340/10.3; 382/107

(57) ABSTRACT

Systems and methods are described for triggering interrogation of RFID tags by an RFID system in different interrogation spaces in response to detection of the presence and/or motion of an object using a machine vision system. One embodiment of the invention includes an RFID exciter configured to communicate with a master controller, where the master controller is configured to control activation of the RFID exciter and a video camera connected to an application server, where the application server is configured to communicate with the master controller. In addition, the video camera is configured to provide a video sequence of a scene to the application server, the application server is configured to store information concerning a region of interest within the scene, the application server is configured to detect motion within the region of interest using the video sequence, the application server is configured to send a trigger message to the master controller in response to the detection of motion within the region of interest, and the master controller is configured to activate the RFID exciter in response to receipt of a trigger message from the application server.

### PRIORITY CLAIM

The present application claims the benefit of U.S. Provisional Application Ser. No. 61/044,893, filed Apr. 14, 2008, the disclosure of which is incorporated by reference herein in its entirety.

### FIELD OF THE INVENTION

The present invention relates generally to RFID systems and more specifically to the use of machine vision to trigger exciters within an RFID system.

### BACKGROUND

RFID systems can be used to track the movement of objects to which RFID tags have been affixed. Due to the limited range and cost of traditional RFID readers, many warehouses use RFID systems where an RFID reader is placed at each entrance and exit of the warehouse (commonly referred to as dock doors) to read RFID tags affixed to goods as they enter and leave the warehouse. In many instances, the RFID readers are triggered to interrogate RFID tags in response to the triggering of a combination of an Infra Red (IR) detector and a Doppler radar, such as a 22 GHz Doppler radar. The IR detector is used to detect the presence of a person and/or forklift in front of a dock door and the Doppler radar is used to detect motion toward or away from the dock door. In real world applications, an IR detector and a Doppler radar are required for each dock door and both the IR detector and the Doppler radar are prone to errors that can result in the failure to trigger the associated RFID reader. In an RFID system, where RFID readers only detect the movement of goods into and out of a space, failure to trigger an RFID reader can create considerable problems with maintenance of an inventory.

A number of developments have enabled the construction of RFID systems capable of interrogating RFID tags throughout large warehouse environments and not simply at dock doors. For example, the STAR system sold by Mojix, Inc. of Santa Monica, Calif. utilizes a distributed exciter architecture that enables RFID tags to be read across a 250,000 square foot area. The distributed exciter architecture employed in the STAR system is described in U.S. patent application Ser. No. 12/054,331 entitled “RFID Systems Using Distributed Exciter Network”, filed Mar. 24, 2008, the disclosure of which is incorporated by reference herein in its entirety. Such systems enable the detection of goods entering and leaving a space, such as a warehouse, and also enable the detection and location of goods throughout the space.

Due to bandwidth and/or power restrictions imposed by regulators in many RFID applications, the number of exciters used to cover a large area can approach 500 and the time taken to read all tags using the exciters can approach 10 seconds. Stated another way, a system that attempts to continuously read tags throughout a large area might only read tags within a given zone, the size of which is typically limited by transmit power restrictions, approximately once every 10 s. A time period of 10 s is long enough that goods bearing RFID tags could move into a interrogation space and out of the interrogation space without being read. As such, the potential exists for so called “roving blind spots”. A “roving blind spot” refers to a path on which goods bearing RFID tags could travel and completely avoid detection by the RFID system despite passing through multiple RFID interrogation spaces.

### SUMMARY OF THE INVENTION

Systems and methods are described for triggering interrogation of RFID tags by an RFID system in different interrogation spaces in response to detection of motion using a machine vision system. In many embodiments, a video camera is used to capture images of a scene and regions of interest are defined within the scene. The RFID system can analyze the captured images to detect motion within a region of interest. In several embodiments, destination points are also defined and the RFID system can determine whether motion is toward a destination. In this way, machine vision can be used to detect movement of objects bearing RFID tags within an RFID interrogation space and to activate the RFID system in response to detected motion having predetermined characteristics. By selectively triggering the RFID system to only read within interrogation spaces where activity of interest is occurring, the RFID system can perform significantly fewer interrogations than a continuously polling system. In effect, the system can initially poll a warehouse to build an initial survey of the RFID tags that are present and their estimated location and then the RFID system can update the survey by polling within specific interrogation spaces when motion is detected within defined regions of interest. In addition to reducing the number of interrogations, the regions of interest can be defined to prevent the occurrence of roving blind spots within the RFID system during polling by providing an interrupt mechanism. In further embodiments, the RFID system is able to estimate the physical location of an RFID tag and to indicate the physical location of the RFID tag on an image captured using the video camera.

One embodiment of the invention includes an RFID exciter configured to communicate with a master controller, where the master controller is configured to control activation of the RFID exciter and a video camera connected to an application server, where the application server is configured to communicate with the master controller. In addition, the video camera is configured to provide a video sequence of a scene to the application server, the application server is configured to store information concerning a region of interest within the scene, the application server is configured to detect motion within the region of interest using the video sequence, the application server is configured to send a trigger message to the master controller in response to the detection of motion within the region of interest, and the master controller is configured to activate the RFID exciter in response to receipt of a trigger message from the application server.

In a further embodiment, the application server is configured to store a destination point associated with the region of interest, determine the direction of the detected motion, and send the trigger message to the master controller in response to a determination that detected motion within the region of interest is in the direction of the destination point.

In another embodiment, the application server is also configured to send a trigger message to the master controller in response to a determination that the detected motion within the region of interest is in a direction away from the destination point.

In a still further embodiment, the application server is configured to detect motion by dewarping the pixels within the region of interest in a pair of images from the video sequence into a uniform sampling resolution, and comparing the dewarped pixels from the pair of images.

In still another embodiment, comparing the dewarped pixels from the pair of images includes determining the mean absolute difference between the dewarped pixels from the pair of images, and determining whether the mean absolute difference exceeds a predetermined threshold.

In a yet further embodiment, the application server is configured to determine the direction of the detected motion by determining motion vectors for blocks within the dewarped pixels from the pair of images, and determining the direction of the detected motion from the motion vectors.

In yet another embodiment, determining the direction of the detected motion from the motion vectors comprises identifying the direction of the non-zero mode motion vector.

In a further embodiment again, the application server is configured to dewarp the pixels within the region of interest by applying a transformation to remove barrel distortion.

In another embodiment again, the application server is configured to dewarp the pixels within the region of interest by applying a transformation to remove perspective distortion.

In a further additional embodiment, the application server is configured to store information concerning a plurality of regions of interest within the scene, the application server is configured to detect motion within any of the plurality of regions of interest using the video sequence, the application server is configured to send a trigger message to the master controller in response to the detection of motion within any of the plurality of regions of interest, and the master controller is configured to activate the RFID exciter in response to receipt of a trigger message from the application server.

In another additional embodiment, the application server is configured to send a trigger message to the master controller in response to the detection of motion within the region of interest provided the motion possesses at least one predetermined characteristic.

In a still yet further embodiment, the at least one predetermined characteristic includes the direction of the motion.

In still yet another embodiment, the at east one predetermined characteristic includes the size of the object moving within the region of interest.

In a still further embodiment again, the at least one predetermined characteristic includes the duration of the observed motion.

Still another embodiment again also includes a second RFID exciter.

In a still further additional embodiment, the application server is configured to store information concerning a second region of interest within the scene associated with the second RFID exciter, the application server is configured to detect motion within the second region of interest using the video sequence, the application server is configured to send a trigger message to the master controller in response to the detection of motion within the second region of interest, and the master controller is configured to activate the RFID exciter in response to receipt of a trigger message from the application server sent in response to the detection of motion within the second region of interest.

Still another additional embodiment includes a plurality of RFID exciters configured to communicate with a master controller, where the master controller is configured to control activation of each of the plurality of RFID exciters, and a video camera connected to an application server, where the application server is configured to communicate with the master controller. In addition, the video camera is configured to provide a video sequence of a scene to the application server, the application server is configured to store information concerning a plurality of regions of interest within the scene, the application server is configured to detect motion within any of the plurality of regions of interest using the video sequence, the application server is configured to send a trigger message to the master controller in response to the detection of motion within one of the plurality the regions of interest, and the master controller is configured to activate at least one of the plurality of RFID exciters in response to receipt of a trigger message from the application server.

In a yet further embodiment again, the master controller is configured to store information associating RFID exciters with regions of interest, the application server is configured to send trigger messages that identify the region of interest in which motion was detected, and the master controller is configured to activate RFID exciters associated with a region of interest identified in a trigger message.

In yet another embodiment again, the application server is configured to store information associating RFID exciters with regions of interest, and the application server is configured to send trigger messages that identify the RFID exciters associated with the region of interest in which motion was detected, and the master controller is configured to activate the RFID exciters identified in a trigger message received from the application server.

In a yet further additional embodiment, the master controller is configured to estimate the location of an RFID tag based upon observations of RFID tag reads in response to activation of a plurality of the RFID exciters over time and the detection of motion within regions of interest.

In yet another additional embodiment, the video camera is one of a plurality of video cameras connected to the application server, each video camera is configured to provide a video sequence of a scene to the application server, the application server is configured to store information concerning a plurality of regions of interest within the plurality of scenes provided by the video cameras, the application server is configured to detect motion within any of the plurality of regions of interest using the video sequence, the application server is configured to send a trigger message to the master controller in response to the detection of motion within one of the plurality the regions of interest, and the master controller is configured to activate at least one of the plurality of RFID exciters in response to receipt of a trigger message from the application server.

A still further additional embodiment again includes an RFID exciter configured to communicate with a master controller, where the master controller is configured to control activation of the RFID exciter, a video camera connected to an application server, where the application server is configured to communicate with the master controller, and a display configured to communicate with the application server. In addition, the video camera is configured to provide a video sequence of a scene to the application server, the master controller is configured to estimate the location of an RFID tag based upon at least the signals backscattered by the RFID tag in response to the activation of the RFID exciter, the application server is configured to render an overlay including a visual indicator in the estimated location of the RFID tag, and the application server is configured to combine the overlay and the video sequence of the scene for viewing via the display.

In another additional embodiment again, rendering an overlay including a visual indicator in the estimated location of the RFID tag further includes mapping the estimated location to pixel positions within the scene, and inserting a visual indicator in the pixel positions corresponding to the estimated location.

In another further embodiment, mapping the estimated location to positions within the scene, includes applying at least one transformation to the estimated location to account for warping introduced into the scene by the camera.

In still another further embodiment, the at least one transformation includes transforming the estimated location to account for barrel distortion introduced into the scene by the camera.

In yet another further embodiment, the at least one transformation includes transforming the estimated location to account for perspective distortion introduced into the scene by the camera.

One embodiment of the method of the invention includes defining a region of interest within a scene captured by a video camera, monitoring a video sequence captured by the video camera to detect motion within the region of interest, and triggering the activation of an RFID exciter associated with the region of interest in response to the detection of motion within the region of interest.

A further embodiment of the method of the invention includes defining a destination point within the scene captured by the video camera, where the destination point is associated with the region of interest, and determining whether the detected motion within the region of interest is toward the destination point. In addition, the RFID exciter is activated in response to the detection of motion toward the destination point within the region of interest.

Another of the method of the invention further includes determining whether the detected motion within the region of interest is away from the destination point. In addition, the RFID exciter is activated in response to the detection of motion away from the destination point within the region of interest.

A still further embodiment of the method of the invention also includes determining the size of the object moving within the region of interest. In addition, the RFID exciter is activated in response to the detection of motion associated with an object having a size exceeding a predetermined threshold within the region of interest.

Still another embodiment of the method of the invention further includes determining the magnitude of the detected motion in multiple successive frames of the video sequence. In addition, the RFID exciter is activated in response to the detection of similar motion within the region of interest in multiple successive frames of the video sequence.

A yet further embodiment of the method of the invention includes estimating the location of the RFID tag using an RFID receiver system, capturing a video sequence of a scene including the object bearing the RFID tag using a video camera, generating an overlay including a visual indication of the location of the RFID tag using the estimated location of the RFID tag provided by the RFID receiver system, and displaying the combined overlay and video sequence.

### BRIEF DESCRIPTION OF THE DRAWINGS

FIG. 1 is a semi-schematic diagram of an RFID system in accordance with an embodiment of the invention.

FIG. 2 is a flow chart showing a process for using video images to activate exciters in an RFID system in accordance with an embodiment of the invention.

FIG. 3 is an image of warehouse dock doors captured using a video camera.

FIG. 4 shows the image in FIG. 3 with portions of the image defined as a region of interest and a destination point in accordance with an embodiment of the invention.

FIG. 5 is a flow chart showing a process for analyzing a frame of video to determine whether to trigger one or more exciters in an RFID system in accordance with an embodiment of the invention.

FIG. 6a is a conceptual illustration of a region of interest and a destination point defined within an image.

FIG. 6b is a conceptual illustration of the result of applying a dewarping transformation to the region of interest and the destination point shown in FIG. 6a in accordance with an embodiment of the invention.

FIGS. 7a-7c are conceptual illustrations of the use of 1, 2 or 3 cameras having different fields of view to capture images of a scene.

FIG. 8 is a conceptual illustration of an RFID system including four exciters located at the corners of a grid of regions of interest in accordance with an embodiment of the invention.

FIG. 9 is a flow chart illustrating a process for generating an overlay showing the location of an RFID tag in accordance with an embodiment of the invention.

### DETAILED DESCRIPTION OF THE INVENTION

Turning now to the drawings, systems and methods for sensor activating an RFID system using a machine vision system are described. In many embodiments, the RFID system includes a video camera that captures video sequences of scenes including one or more regions of interest proximate a interrogation space. The interrogation space can be the area in which an RFID reader can read RFID tags or in which an exciter in an RFID system having a distributed exciter architecture can excite an RFID tag. Throughout the description that follows the term RFID exciter is used to refer to either an RFID reader performing the transmit function during RFID interrogation or an exciter in an RFID system having a distributed exciter architecture. In several embodiments, the images are analyzed to detect motion within a region of interest. In a number of embodiments, one or more destination points are defined for a region of interest and motion within a region of interest is analyzed to determine whether the motion is toward a destination point. When motion possessing predetermined characteristics is detected, the RFID system is triggered to interrogate RFID tags in one or more interrogation spaces associated with the region of interest. When the object moving within the region of interest includes one or more RFID tags, then the RFID system can obtain information from the RFID tags.

In many embodiments, video cameras can capture views of a scene such as a series of warehouse dock doors. Regions of interest within the scene can be defined within the view captured by the camera. As part of the detection process, distortions introduced by the camera are removed via a dewarping transformation to provide an image having a uniform sampling resolution. The distortions introduced by the camera typically depend upon the camera's lens and orientation relative to the scene.

By defining regions of interest within a scene, images captured of the scene can be analyzed to detect motion within regions of interest and the direction of motion. In embodiments deployed in warehouses, motion of interest is presumed to be large objects such as pallets of goods and/or forklifts. Therefore, the system discriminates between motion of smaller and larger objects moving through a region of interest when determining whether to trigger the RFID system to read RFID tags within one or more interrogation spaces associated with the region of interest.

In a number of embodiments, the RFID system can locate RFID tags using the RF signals received from the tags. Using transformations that are the inverse of those employed to dewarp images captured by the camera, the physical location of an RFID tag can be shown on the image captured by the camera. In many embodiments, the physical location of an RFID tag is shown using a visual indicator. In several embodiments, the RFID system includes a user interface that enables the querying of the system for a particular item bearing an RFID tag and the RFID system can display a captured image of a scene containing the item and including a visual indicator showing the location of the item.

### System Architecture

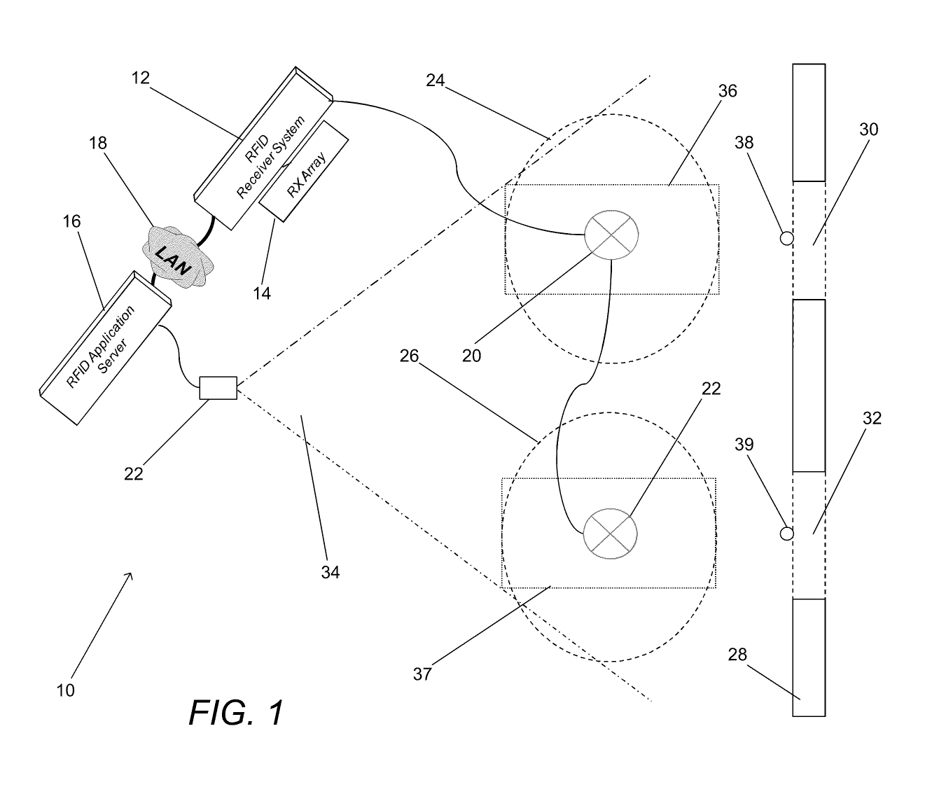

An RFID system including a distributed exciter architecture and a video camera capable of capturing images of a scene including regions of interest in accordance with an embodiment of the invention is shown in FIG. 1. The RFID system 10 includes an RFID receiver system 12 that is connected to a receiver antenna 14, which in the illustrated embodiment is an antenna array. The RFID receiver system 12 is connected to an RFID application server 16 via a network 18. A pair of exciters 20, 22 is connected to the RFID receiver system 12. In the illustrated embodiment, the exciters are connected in a daisy chain to the RFID receiver system via cables. In many embodiments, the exciters can be connected in a variety of other wired configurations or communicate with the RFID receiver system via wireless connections. In several embodiments, the RFID receiver system includes a master controller that can perform a number of functions including scheduling the activation of the exciters. In many embodiments, the master controller utilizes space, time and/or frequency diversity to increase the number of exciters that can be active simultaneously.

When the exciter is activated, the exciter can interrogate RFID tags within an area surrounding the exciter. The area can be referred to as an interrogation space 24, 26. The extent of the interrogation space is determined by the configuration of the exciter. In many embodiments, the RFID system can control the extent of the interrogation space by providing configuration instructions to the exciter. In the illustrated embodiment, the exciters are positioned in front of a pair of dock doors 30, 32 in a warehouse 28. The first exciter 20 is positioned to create a first interrogation space 24 in front of the first dock door 30. The second exciter 22 is positioned to create a second interrogation space 26 in front of the second dock door 32. When the first exciter 20 is activated, the exciter can interrogate RFID tags affixed to goods entering or exiting the warehouse 28 through the first dock door 30. Similarly, the second exciter 22 can interrogate RFID tags affixed to goods entering or exiting the warehouse 28 through the second dock door 32.

A video camera captures a scene that is determined by the orientation of the camera and the field of view of the camera. In the illustrated embodiment, the video camera 22 is positioned so that the field of view 34 of the camera captures a scene that includes the interrogation spaces 24, 26 surrounding the exciters 20, 22. In a number of embodiments, regions of interest 36, 37 are defined within the scene and information concerning the location of the regions of interest within the scene is stored by the RFID application server 16. Regions of interest correspond to physical areas within a scene. The RFID application server can analyze the images of the scene captured by the video camera and detect motion within the regions of interest. In the illustrated embodiment, a first region of interest 36 is defined in a location in front of the first dock door 30 and a second region of interest 32 is defined in a location in front of the second dock door 32. When motion is detected within either region of interest by the RFID application server 16, a trigger message is provided to the master controller of the RFID receiver system 12 and the master controller causes one or more exciters to be activated.

In several embodiments, the master controller stores information concerning exciters associated with specific regions of interest and the trigger message identifies the region of interest that in which the triggering event occurred. In other embodiments, the application server stores information concerning exciters associated with specific regions of interest and the trigger message identifies the exciters that are associated with the region of interest in which the triggering event occurred. In a number of embodiments, the master controller causes the exciter to be activated by inserting the exciter into the RFID receiver system's activation schedule. Inserting the exciter into the activation schedule can involve interrupting an existing schedule, such as a polling schedule. In several embodiments, exciters are only triggered in response to specified motion within a region of interest. In many embodiments, an exciter is only triggered when the motion is in a predetermined direction. In the illustrated embodiment, destination points 38, 39 are defined within the scene to indicate motion of interest. A first destination point 38 is defined to enable the RFID application server to ascertain whether motion in the first region of interest 36 is towards (or away from) the first dock door 38. A second destination point 39 is defined to enable the RFID application server to ascertain whether motion in the second region of interest 37 is toward (or away from) the second dock door 39.

In a number of embodiments, the RFID application server only sends a trigger message to the master controller when detected motion satisfied one or more predetermined conditions, such as the motion being associated with an object exceeding a predetermined size threshold. In other embodiments, exciters are triggered in response to various motion requirements including combinations of motion requirements.

Although the embodiment shown in FIG. 1 includes a distributed exciter architecture, systems that use multiple RFID readers instead of a distributed exciter architecture and/or multiple RFID systems can be triggered to read RFID tags within one or more interrogation spaces in response to the detection of motion within one or more regions of interest using video cameras in accordance with embodiments of the invention. In addition, regions of interest can be defined anywhere within a space and is not limited to sensing adjacent dock doors. Accordingly, similar systems and methods can be utilized in combination with any of a variety of RFID systems.

### Triggering Exciters in Response to Motion Detection

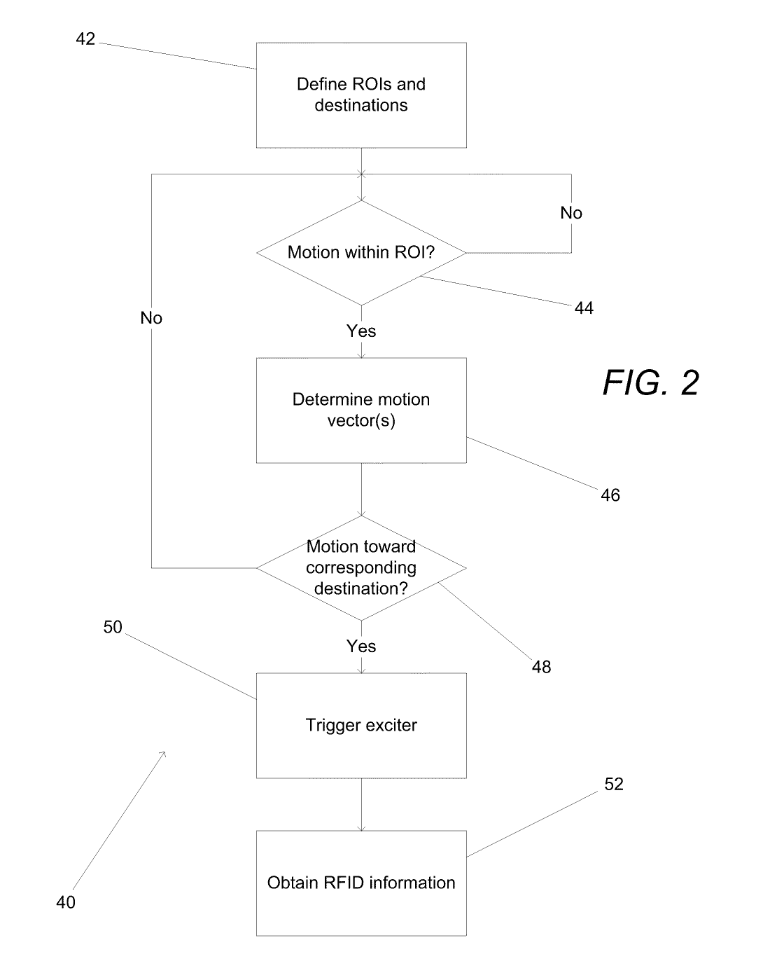

A process for triggering one or more exciters in response to motion within a region of interest in a predetermined direction is shown in FIG. 2. The process 40 includes defining (42) regions of interest and destination points within a scene. The scene is then analyzed to detect (44) motion within the regions of interest. When motion is detected within the region of interest, the motion vector of the object(s) moving within the region of interest is determined (46). A decision (48) is then made as to whether the motion is toward (or away from) the destination point associated with the region of interest. In the event that the motion is not toward (or away from) the destination, then the system continues to monitor for motion within the regions of interest that is toward (or away from) an associated destination point. When the motion is toward (or away from) a destination point, then a master controller within the RFID system schedules the activation (50) of one or more exciters associated with the region of interest. The RFID system can then obtain information from RFID tags affixed to the object or objects based upon RFID tag reads that occur in response to the activation of each of the one or more exciters. Although a specific process is outlined above, other processes in accordance with embodiments of the invention can be used to detect motion of interest and trigger reading of RFID tags within one more interrogation spaces associated with a region of interest.

### Capturing Images

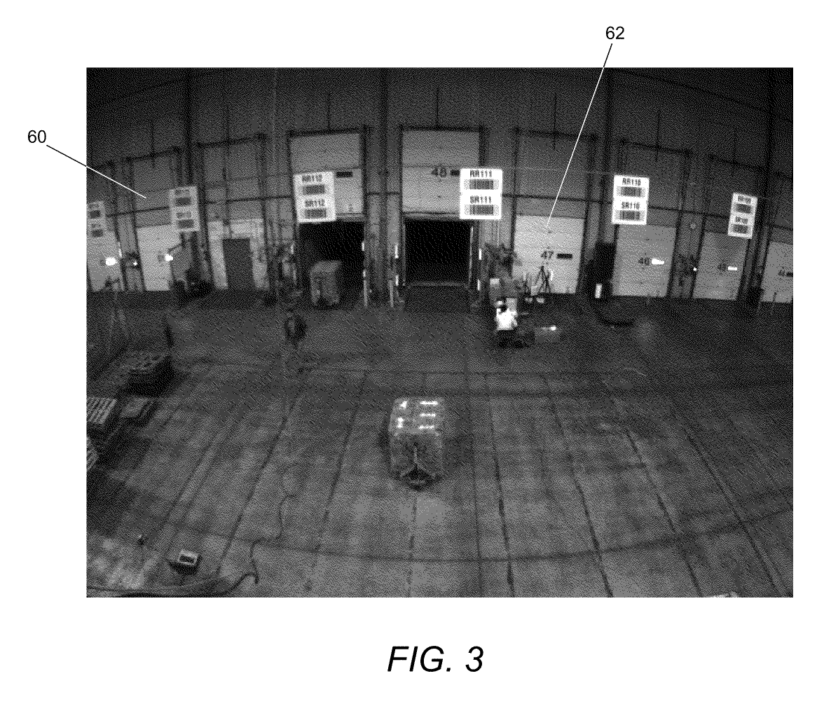

A scene of a warehouse captured by a video camera positioned in a perspective view is shown in FIG. 3. The scene 60 includes a number of dock doors 62. The positioning of the camera relative to the scene is such that images captured by the video camera are distorted. The distortions can include barrel distortions and perspective distortions associated with the use of wide angle tenses.

Barrel distortions are distortions that result in physically straight lines not appearing straight in a captured image. Barrel distortion is constant for a given zoom setting and can be parameterized. The distortions can also include perspective distortions associated with the positioning of the camera.

Perspective distortions typically arise when a wide-angle lens is used, because the pixels in a captured image represent different size physical areas of the scene. When the camera is mounted so that it is viewing the scene from an oblique angle, then the distance from the camera to the floor of the scene (assuming the floor is level) varies depending on the location of the floor of the scene. The varying distance causes a perspective distortion in the captured image. In many embodiments, a video camera is mounted directly above the warehouse floor so that the camera imaging plane is parallel to the floor of the scene. The result is a bird's eye view, which typically does not involve perspective distortions. Compensating for various distortions is discussed below.

### Defining Regions of Interest

RFID systems in accordance with embodiments of an invention enable one or more regions of interest to be defined within a scene captured by a camera. In many embodiments, the process of defining a region of interest involves physically marking out the region of interest within the scene. The RFID system can then capture an image of the scene including the marked out region of interest and a user can use the captured image to indicate to the RFID system the pixels in the captured image defining the boundary of the region of interest. In many embodiments, the shape of a region of interest is constrained to a shape such as a rectangle and the region of interest can be defined by indicating the pixels in a captured image corresponding to the four corners of the rectangle. The side lengths of the rectangle can be measured and the side lengths used to calculate a dewarping transformation that can be used to eliminate distortions. The determination of dewarping transformations is discussed further below. The dewarping transform is also applied to the destination coordinate, so the destination coordinate is accurately represented in the dewarped coordinate system. It is not necessary to make any physical measurements of the destination coordinate in the actual physical world and in a number of embodiments, regions of interest are defined using pixels from an image of a scene. In many embodiments, multiple regions of interest are defined within a single scene captured by a video camera enabling motion within a single region of interest to drive the activation of multiple RFID exciters.

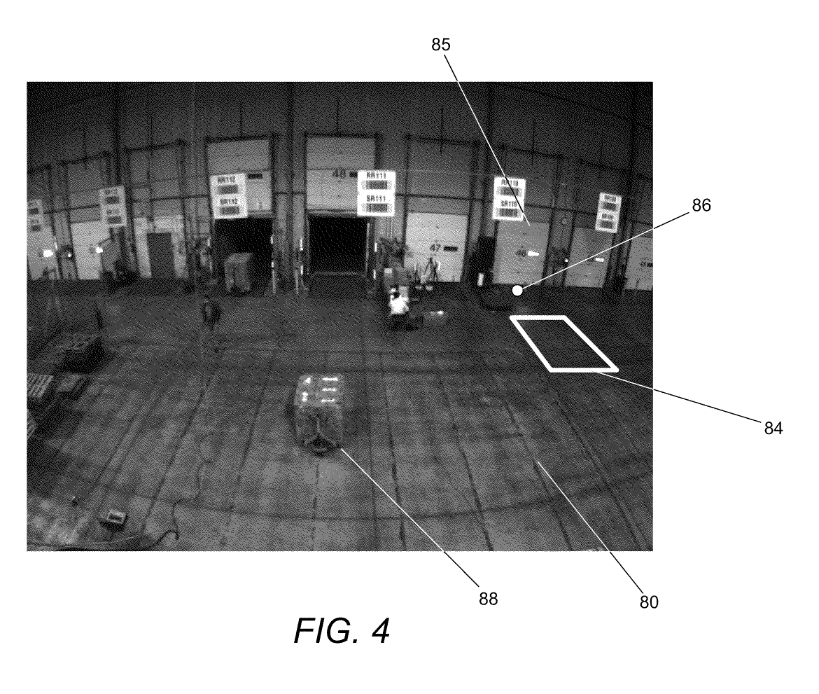

Once regions of interest and destination points have been defined, the physical markings, which identified the pixels corresponding to the perimeter of the region of interest can be removed from the scene. The RFID system can indicate regions of interest and destination points on images captured of the scene by creating an overlay. The superposition of a region of interest and destination point on an image of a scene capture by a video camera in accordance with an embodiment of the invention is shown in FIG. 4. The scene is the scene shown in FIG. 3 with the addition of a region of interest 84 and a destination point 86. As discussed above, the scene is of a warehouse. The region of interest is defined in front of a dock door 85 and, while rectangular in the actual scene, appears warped due to the perspective distortion of the camera. The destination point is defined at the base of the dock door 85. The region of interest 86 defines an area within the image in which the RFID system watches for motion. Detecting motion within the region of interest, determining the direction of the motion and discriminating between different types of motion, such as discriminating between pallets of goods 88, and smaller objects, such as people 89, are discussed below.

### Determining Direction of Motion

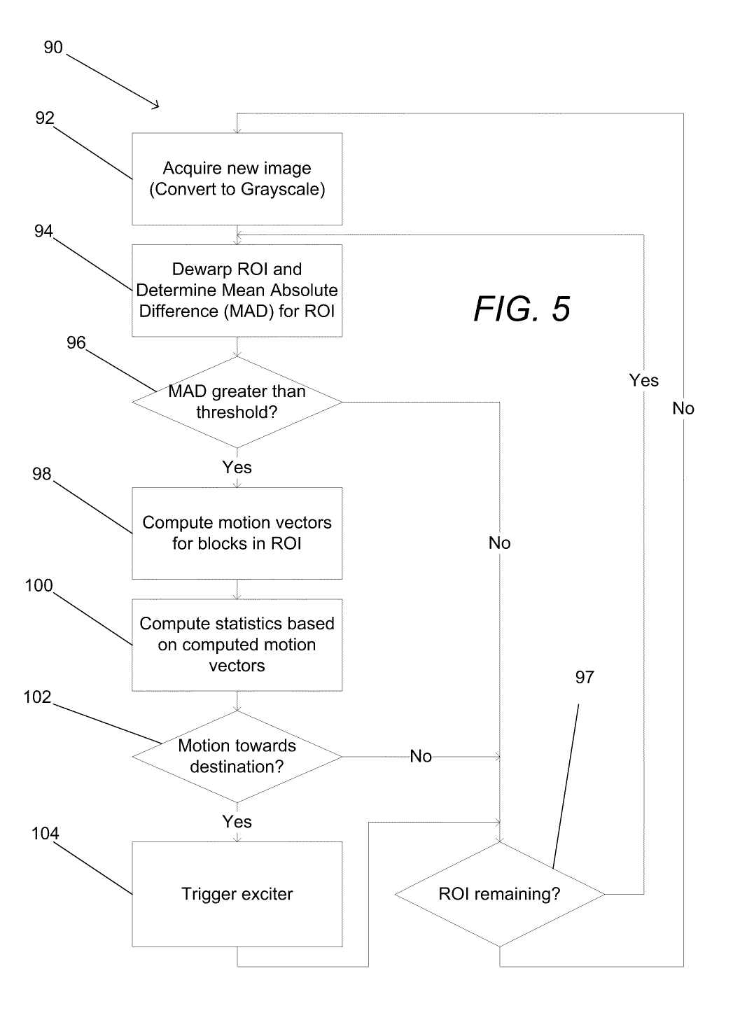

A process for detecting motion, determining direction of motion and triggering an exciter in accordance with an embodiment of the invention is shown in FIG. 5. The process 90 involves comparing images in a video sequence. The process includes acquiring (92) a new image and selecting a first region of interest to analyze. The pixels within the region of interest are dewarped into a uniform sampling resolution and the pixel data of the region of interest from the previous and current frames are compared to determine if there is any activity. In the illustrated embodiment, the mean absolute difference is used to detect activity. The mean absolute difference is computed by dividing the sum of the absolute value of the difference between the dewarped pixel values within the region of interest in each frame by the number of pixels in the dewarped region of interest. Motion is detected (96) when a determination is made that the mean absolute difference is greater than a predetermined threshold. Factors that influence the choice of the threshold include, but are not limited to, environmental lighting conditions, camera gain and exposure time. When the environmental lighting changes predictably over time, then the threshold can be adjusted over time accordingly. In many embodiments, the adjustment is an adaptive process.

When motion is detected, the direction of the motion can be determined by computing (100) the motion vectors for the blocks within the region of interest and by extracting (102) statistics indicative of the direction of motion from the motion vector information. In embodiments where motion of interest involves rigid objects, the non-zero mode motion vector can be used to determine the direction of motion of an object within a region of interest. In other embodiments, other statistics can be used to determine the direction of motion of an object within a region of interest in accordance with the requirements of the application.

A determination is made (102) as to whether the direction of motion is toward (or away from) a destination point. When the direction of motion is toward (or away from) a destination point, then one or more exciters located proximate the region of interest are scheduled for activation by the RFID system to interrogate any RFID tags affixed to the object or objects located within the region of interest.

Although much of the discussion that follows focuses on the detection of motion in general, a specific case of motion detection is presence detection. Presence detection is the detection of an object within a region of interest and can be performed by comparing an image captured by the video camera with a previously captured reference image in which no objects are present within the region of interest. By performing the motion detection processes described herein with respect to the reference image, RFID systems in accordance with embodiments of the invention are able to detect the presence of objects within a region of interest in addition to being able to detect motion and/or the direction of the motion of objects within the region of interest. In several embodiments, presence detection can be useful for interrogating RFID tags when the object(s) bearing the RFID tags move into a region of interest and remain stationary there for some time. An example of such a situation is when a pallet is moved into location before a dock door prior to loading or following unloading of a truck and remains there for some time. Using presence detection, the system knows to continuously interrogate the stationary RFID tags when motion detection would not otherwise provide a trigger.

### Dewarping

When an image is captured of a scene, distortions introduced by the lens of a camera result in image pixels that represent different size areas of physical space. The pixels can be dewarped so that each dewarped pixel corresponds to the same amount of physical space. The dewarping transformation depends upon the nature of the distortion. Both barrel distortion and perspective distortion are typically considered when dewarping an entire frame. In some embodiments, barrel distortion can be ignored when small portions of an image, such as a region of interest, are dewarped.

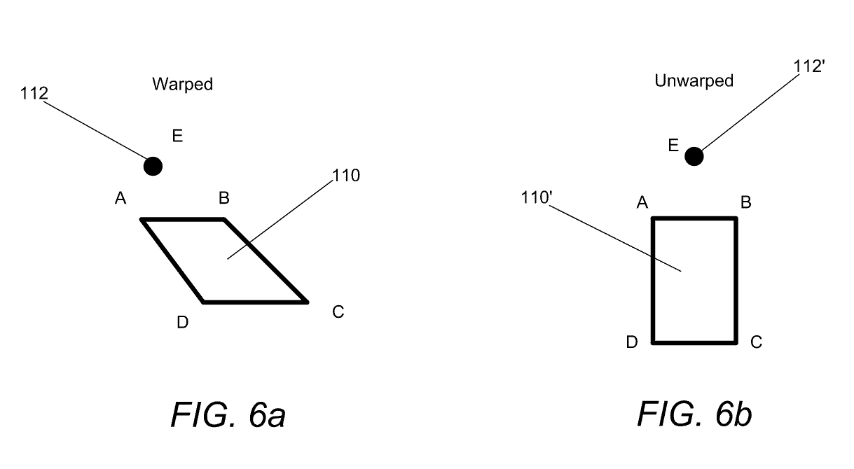

Dewarping the pixels in a region of interest enables the tracking of motion within the region of interest and the determination of the real-world speed of a moving object. The appropriate dewarping transformation can be determined during the definition of the region of interest. The dewarping transformation dewarps the pixel information within the quadrilateral region of interest to a rectangular region of interest (the shape of the region of interest in physical space), which has a uniform sampling resolution. The chosen uniform sampling resolution can be arbitrary, for example 1 cm/pixel, 4 cm/pixel, 0.25 cm/pixel. In many embodiments, the uniform sampling resolution is chosen to correspond to the highest sampling resolution within the region of interest. In other embodiments, a sampling resolution appropriate to the application is chosen. The dewarping of a region of interest is illustrated in FIGS. 6a and 6b. The quadrilateral region of interest 110 and destination point are transformed to a rectangular region of interest 110′ and destination point aligned in the position of the destination point relative to the dewarped region of interest in physical space.

In several embodiments, the dewarping transformation is a 3×3 matrix that warps a two dimensional homogenous coordinate system to a different two dimensional homogeneous coordinate system. Processes for inferring 3×3 matrix transforms are outlined in Paul Heckbert's 1989 thesis “Fundamentals of Texture Mapping and Image Warping” (Available: http://www.cs.cmu.edu/˜ph/texfund/texfund.pdf), the disclosure of which is incorporated by reference herein in its entirety. In embodiments where the regions of interest are defined as rectangles in physical space, a dewarping transform is obtained by determining the transformation required to map the corners of the quadrilateral region of interest from the image onto the corners of a rectangle having the physical dimensions of the region of interest. The transformation is determined by solving an 8×8 linear system for the 8 unknowns that make up the coefficients of the 3×3 transform matrix (the last element of the 3×3 matrix is 1, so there are 8 unknowns). The transformation can also be determined by choosing four points from regions of interest that are not rectangular. In other embodiments, any of a variety of other techniques can be used to dewarp the region of interest to have a uniform sampling resolution.

### Detecting the Presence of Motion

When a region of interest has been dewarped into a uniform sampling resolution, the pixel data from the previous and current dewarped region of interest are compared to determine if there is any activity. In several embodiments, activity is measured by calculating mean absolute difference. Mean absolute difference can be computed by dividing the sum of the absolute value of the difference between the previous pixel value and the current pixel values, and then dividing the sum by the number of pixels in the dewarped region of interest. If the acquired image is a color image, the acquired image can be converted to grayscale before further processing. Motion can be detected by establishing a threshold for the mean absolute difference that is indicative of motion. If the mean absolute difference is above the threshold, then a determination is made that motion is present within the region of interest. The value of the threshold depends upon the application and can vary with time in response to predictable changes, such as environmental lighting. The changes can be an adaptive process.

Although detection of motion using mean absolute values is discussed above, motion can be detected using a variety of other techniques appropriate to the application.

### Computing Motion Vectors

Motion vectors within a dewarped region of interest can be determined in a number of ways that involve comparing pixel data from one frame to pixel data from the previous frame. In many embodiments, a full search is performed. The number of comparisons performed is equal to N*N*M*M where N is the block size, and M is the search range. Depending upon the size of the moving objects, the block size can be 32 pixels×32 pixels, 16 pixels×16 pixels, 8 pixels×8 pixels or 4 pixels×4 pixels. In a number of embodiments, a block size of 16 pixels×16 pixels is chosen. Although in other embodiments, other block sizes including rectangular block sizes are chosen. The search range is typically determined based upon the anticipated object speed, camera frame rate, and uniform sample resolution. As an example, objects moving at a maximum speed of 1 meter per second, with frame rate of 10 frames per second with a sampling resolution of 1 centimeter per pixel will result in a maximum anticipated movement of 10 pixels per frame. Therefore, an appropriate search range would be at least 10 pixels but preferably a little more.

In a number of embodiments, fast motion searching algorithms are used that perform fewer comparisons by searching at a small fraction of the possible search locations. In many embodiments, a fast motion search algorithm known as the “N-Step Search” is used. The N-Step Search algorithm is described in the following texts:
T. Koga, K. Iiunuma, A. Hirani, Y. Iijima, and T. Ishiguro, “Motion Compensated Interframe Coding for Video Conferencing” Proceedings of the Telecommunications Conference, 1981, pp. G.5.31-G.5.35.
Chap 7, section 7.2.2 of the book by Ian E. G. Richardson “H.264 and MPEG-4 Video Compression”, Wiley 2003.
Chap 4, section 3.4.2 of the book by Borko Furht, Joshua Greenburg and Raymond Westwater “Motion Estimation Algorithms for Video Compression”, Kluwer 1997.

The disclosure of the above references is incorporated by reference herein in its entirety. In other embodiments, any of a variety of motion detection algorithms appropriate to the application is used, including but not limited to algorithms that use feature recognition.

### Analyzing Motion Vectors to Determine Direction of Motion

The motion vectors for blocks in a region of interest can be used to determine the direction of motion of an object. In a number of embodiments, the distribution of the motion vectors is analyzed to obtain the direction of motion. In several embodiments, moving objects are assumed to be rigid (e.g. a forklift or a palette of goods). Therefore, movement of the object will appear as a series of blocks with parallel motion vectors. In several embodiments, the motion vector of a moving object is ascertained by selecting the mode non-zero motion vector. The mode non-zero motion vector can be determined by building a two-dimensional histogram of the motion vectors. In other embodiments, other techniques can be used for estimating the motion vector of an object moving within the region of interest.

### Triggering Exciters

A decision to trigger an exciter in response to the detection of an object moving within a region of interest typically depends upon whether the object is moving toward a destination point. In a number of embodiments, the difference between the angle of the estimated motion vector of the object and the angle between the center of the region of interest and the destination point is computed. In several embodiments, the angle is determined via a dot product calculation. When the difference angle is less than a predetermined threshold, the object is assumed to be moving toward the destination point. When the angle is close to 180 degrees, then motion is detected as moving away from the destination coordinate (in several embodiments, movement toward and/or away from a destination coordinate results in the triggering of an exciter).

Exciters can be triggered when motion toward a destination coordinate is detected. In many embodiments, additional requirements must be satisfied prior to the triggering of an exciter. In several embodiments, absolute size and constant velocity requirements are also imposed to avoid false alarms related to movement of small objects like people or debris toward the destination coordinate, and/or movement of reflected light captured by the camera. The absolute size and constant velocity of the object moving within the region of interest can be determined by examining the number of blocks possessing the mode motion vector and/or requiring that the motion be observed across several frames before triggering an exciter (i.e. the object's motion have substantially constant velocity over a predetermined time period). In other embodiments, a variety of requirements can be imposed and a number of processing techniques can be used to determine whether the requirements are satisfied.

Much of the discussion of the detection of motion assumes that the video camera captures uncompressed images of the scene. For example, the methods described above can be implemented using a USB RAW camera. In a number of embodiments, however, the camera outputs compressed video. When the compressed video includes motion vector information (e.g. MPEG-2, MPEG-4, or H.264), the motion vectors within the compressed video stream can be used to determine direction of motion provided the motion vectors include a sufficiently low level of quantization noise.

### Accommodating Camera Field of View

When a camera is mounted to observe a scene in accordance with an embodiment of the invention, the extent of the scene captured by the camera is dependent upon the camera position and the camera's field of view. In many embodiments, a camera with a wide angle lens is used to capture as much of the scene as possible. The field of view of the camera depends on the focal length of the lens and the camera's sensor size. The relationship can be expressed as follows:

Field of View=2*arctan(Sensor Width/(2*Focal Length))

The following table provides examples of the field of view for various common lens/sensor combinations.

| | Horizontal Field of View (degrees) | | | | | | | |
|---|---|---|---|---|---|---|---|---|
| | Focal length | | | | | | | |
| sensor | | | 6.5 | | 12 | | | |
| size | 2 mm | 4 mm | mm | 8 mm | mm | 20 mm | 40 mm | 50 mm |
| ¼″ | 77° | 43° | 28° | 23° | 15° | 9° | 5° | 4° |
| ⅓″ | 100° | 62° | 41° | 33° | 23° | 14° | 7° | 5° |
| ½″ | 116° | 77° | 52° | 43° | 30° | 18° | 9° | 7° |
| ⅔″ | 131° | 95° | 68° | 57° | 40° | 25° | 13° | 10° |
| 1″ | 145° | 116° | 89° | 77° | 56° | 35° | 18° | 15° |

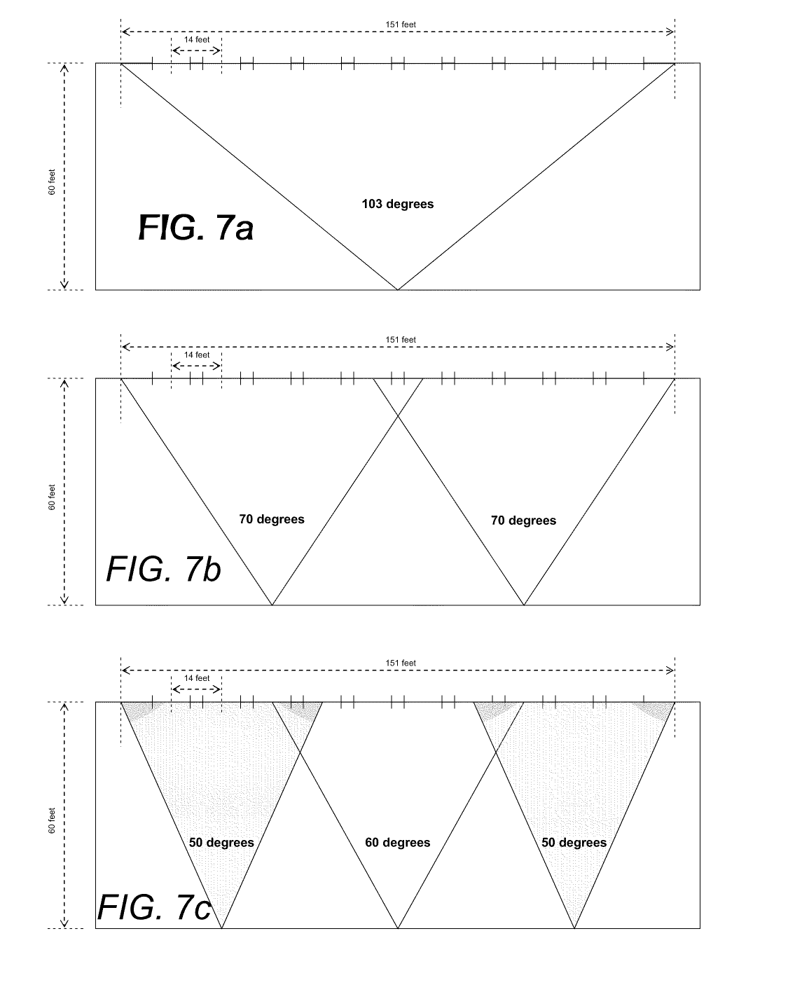

Although many of the embodiments described above utilize a single camera, a number of embodiments of the invention use two or more cameras to observe various regions of interest. Similar image processing can be performed on the images captured by each camera. FIGS. 7a-7c illustrate various configurations involving the use of 1, 2 and 3 cameras to view the same area.

### Positioning the Camera to Provide a Bird's Eye View

In a number of embodiments, the RFID system includes a camera mounted to provide a bird's eye view. In several embodiments, a camera is mounted directly above the dock door of a warehouse or in the ceiling looking down on staging areas and vertically racked shelving. Mounting a camera in this way enables the use of different processes for detecting the direction of motion. In a number of embodiments, the angle between the motion vector of each block in the region of interest and the destination coordinate is computed and the angle of each motion vector is compared to the angle between the block and the destination point. A histogram can then be built using the difference angle for all of the blocks, and the mode angle selected. In the event that the mode angle is less than a predetermined threshold (or close to 180 degrees), then motion of an object within the region of interest is determined to be in the direction (or moving away from) the destination point. In other embodiments, various techniques can be used to determine whether an object moving within a region of interest is moving toward or away from a destination point. Additional detection requirements, such as absolute size and constant velocity, can be added to improve false alarm rejection.

### Enhanced Location Estimation Using Motion Detection

RFID systems can use signals backscattered by RFID tags to determine the location of the RFID tags in a variety of ways. Techniques for locating RFID tags are disclosed in the U.S. patent application entitled “Radio Frequency Identification Tag Location Estimation and Tracking System and Method”, filed Apr. 14, 2009, having attorney docket M7:01338, the disclosure of which is incorporated by reference herein in its entirety. In many such systems, location estimation is performed using statistical analysis of signals received in response to the excitation of specific exciters. RFID systems in accordance with embodiments of the invention can enhance location estimation using additional information obtained through analysis of video sequences captured by one or more video cameras. A plurality of regions of interest can be defined within a scene and the detection of motion within a region of interest can be used by the RFID system as an additional piece of information when performing location estimation at the time the motion was detected.

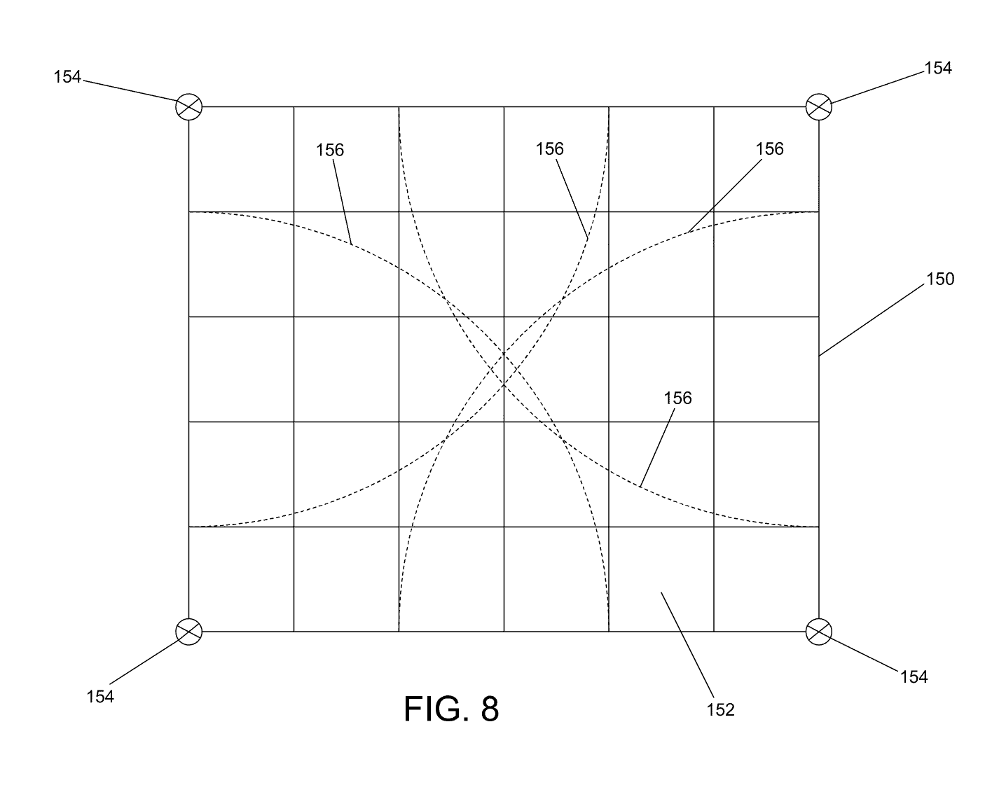

An RFID system including four exciters at the corners of a grid of regions of interest in accordance with an embodiment of the invention is conceptually illustrated in FIG. 8. In the illustrated embodiment, a grid 150 of square regions of interest 152 is defined and RFID receivers 154 are placed at the four outermost corners of the grid. Each RFID receiver is shown having a interrogation space 156, however, many factors influence the distance over which an exciter can transmit a signal that is capable of being backscattered and read by an RFID tag. Therefore, the interrogation spaces are mainly for illustrative purposes. As discussed above, estimates of the locations of RFID tags can be made by observing signals backscattered by RFID tags over time as each of the exciters are activated. When the RFID system detects motion in one of the regions of interest 152, the estimation process can also utilize the motion detection information to improve location estimates. For example, a location estimation based upon RFID tag reads may place a tag close to a region of interest at the time motion is detected within the region of interest. The fact that motion is detected and that the location of the tag changes with time in a similar manner to the tracked motion can be used to constrain location estimates within appropriate regions of interest. In other embodiments, motion detection information can be used to improve location estimations in any of a number of different ways appropriate to the specific application including motion estimation using a statistical model such as a particle filter.

In the embodiment illustrated in FIG. 8, the scene in which the regions of interest are defined is captured from a bird's eye view. Location estimates can be improved with information captured from other perspectives in accordance with embodiments of the invention. Furthermore, a master controller can be used to perform the location estimation based upon RFID tag read information accumulated in response to the activation of various exciters over time, and the detection of motion within regions of interest. Alternatively, the location estimation can be performed by a separate application server.

### Indicating the Location of RFID Tags on an Image

Much of the above discussion relates to determining the location and destination of RFID tags affixed to objects that are in motion as viewed in a video sequence. RFID systems in accordance with embodiments of the invention use machine vision to identify moving objects in regions of interest that might contain RFID tags. When an object or objects exhibiting motion of interest are identified, the RFID system attempts to identify the object or objects by interrogating any RFID tags affixed to the object or objects. As discussed above, U.S. patent application entitled “Radio Frequency Identification Tag Location Estimation and Tracking System and Method”, filed Apr. 14, 2009, having attorney docket M7:01338, describes processes for estimating the location of an RFID tag. RFID systems in accordance with embodiments of the invention can estimate location of an RFID tag within a scene and use the coordinates of the estimated location to show the location of the tag on an image of the scene captured by a camera.

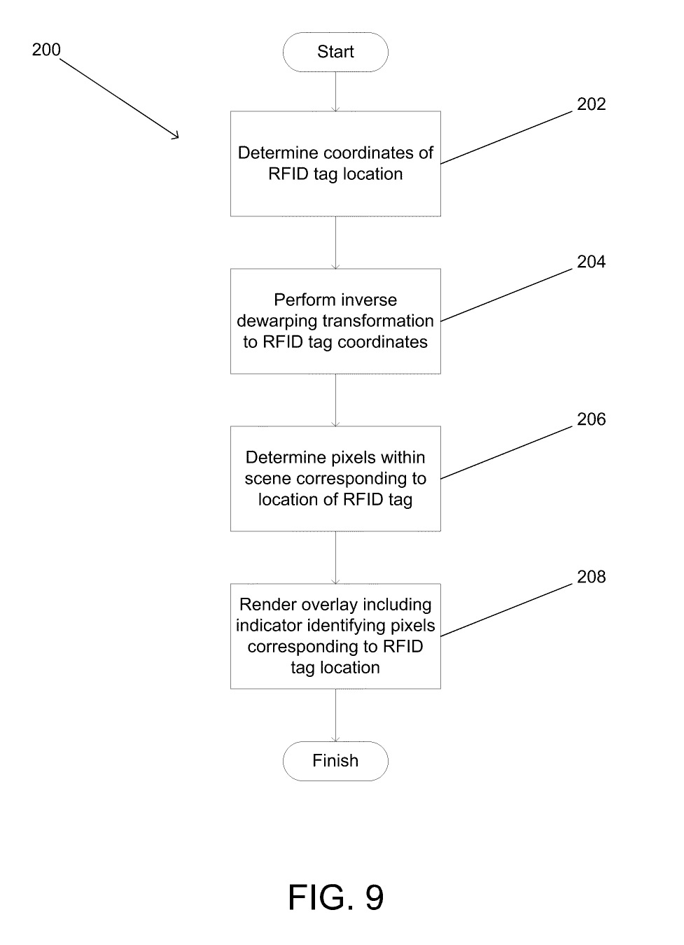

A process for overlaying a visual indicator onto a scene to show the location of an RFID tag in accordance with an embodiment of the invention is shown in FIG. 9. The process 200 includes determining (202) the coordinates of the location of an RFID tag using an RFID receiver system. The coordinates of the RFID tag's location are then transformed (204) to accommodate any distortions introduced by the camera. In several embodiments, a perspective distortion is applied to the coordinates of the RFID tag's physical location using the inverse transformation of the dewarping transformation described above. In some embodiments, barrel distortion may be applied to the coordinates of the RFID tag location within the camera image. The transformation enables a determination (206) of the pixels in the scene corresponding to the location of the RFID tag. An overlay can then be rendered (208) that includes a visual indication of the location of the RFID tag and the overlay applied to a captured image of the scene. As the location of the RFID tag changes, the overlay can be continuously updated. Although a specific process is shown in FIG. 9, other processes appropriate to the generation of an overlay by mapping location information generated by an RFID system into pixel locations can be used in accordance with embodiments of the invention.

In several embodiments, the visual indicator used in the overlay is a rectangle. In a number of embodiments, the size of the rectangle is determined based upon the confidence level of the location estimate. In other embodiments, various different types of visual indicators can be used to indicate the location of the RFID tag and/or the confidence of the location estimate in accordance with the requirements of the application.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. An RFID system, comprising:
an RFID exciter configured to communicate with a master controller, where the master controller is configured to control activation of the RFID exciter; and
a video camera connected to an application server, where the application server is configured to communicate with the master controller;
wherein the video camera is configured to provide a video sequence of a scene to the application server;
wherein the application server is configured to store information concerning a region of interest within the scene;
wherein the application server is configured to detect motion within the region of interest using the video sequence;
wherein the application server is configured to send a trigger message to the master controller in response to the detection of motion within the region of interest; and
wherein the master controller is configured to activate the RFID exciter in response to receipt of a trigger message from the application server.

2. The RFID system of claim 1, wherein the application server is configured to:
store a destination point associated with the region of interest;
determine the direction of the detected motion; and
send the trigger message to the master controller in response to a determination that detected motion within the region of interest is in the direction of the destination point.

3. The RFID system of claim 2, wherein the application server is also configured to send a trigger message to the master controller in response to a determination that the detected motion within the region of interest is in a direction away from the destination point.

4. The RFID system of claim 2, wherein the application server is configured to detect motion by:
dewarping the pixels within the region of interest in a pair of images from the video sequence into a uniform sampling resolution; and
comparing the dewarped pixels from the pair of images.

5. The RFID system of claim 4, wherein comparing the dewarped pixels from the pair of images comprises:
determining the mean absolute difference between the dewarped pixels from the pair of images; and
determining whether the mean absolute difference exceeds a predetermined threshold.

6. The RFID system of claim 4, wherein the application server is configured to determine the direction of the detected motion by:
determining motion vectors for blocks within the dewarped pixels from the pair of images; and
determining the direction of the detected motion from the motion vectors.

7. The RFID system of claim 6, wherein determining the direction of the detected motion from the motion vectors comprises identifying the direction of the non-zero mode motion vector.

8. The RFID system of claim 4, wherein the application server is configured to dewarp the pixels within the region of interest by applying a transformation to remove barrel distortion.

9. The RFID system of claim 8, wherein the application server is configured to dewarp the pixels within the region of interest by applying a transformation to remove perspective distortion.

10. The RFID system of claim 1, wherein:
the application server is configured to store information concerning a plurality of regions of interest within the scene;
the application server is configured to detect motion within any of the plurality of regions of interest using the video sequence;
the application server is configured to send a trigger message to the master controller in response to the detection of motion within any of the plurality of regions of interest; and
the master controller is configured to activate the RFID exciter in response to receipt of a trigger message from the application server.

11. The RFID system of claim 1, wherein the application server is configured to send a trigger message to the master controller in response to the detection of motion within the region of interest provided the motion possesses at least one predetermined characteristic.

12. The RFID system of claim 11, wherein the at least one predetermined characteristic includes the direction of the motion.

13. The RFID system of claim 11, wherein the at least one predetermined characteristic includes the size of the object moving within the region of interest.

14. The RFID system of claim 11, wherein the at least one predetermined characteristic includes the duration of the observed motion.

15. The RFID system of claim 1, further comprising a second RFID exciter.

16. The RFID system of claim 15, wherein:
the application server is configured to store information concerning a second region of interest within the scene associated with the second RFID exciter;
the application server is configured to detect motion within the second region of interest using the video sequence;
the application server is configured to send a trigger message to the master controller in response to the detection of motion within the second region of interest; and
the master controller is configured to activate the RFID exciter in response to receipt of a trigger message from the application server sent in response to the detection of motion within the second region of interest.

17. An RFID system, comprising:
a plurality of RFID exciters configured to communicate with a master controller, where the master controller is configured to control activation of each of the plurality of RFID exciters; and
a video camera connected to an application server, where the application server is configured to communicate with the master controller;
wherein the video camera is configured to provide a video sequence of a scene to the application server;
wherein the application server is configured to store information concerning a plurality of regions of interest within the scene;
wherein the application server is configured to detect motion within any of the plurality of regions of interest using the video sequence;
wherein the application server is configured to send a trigger message to the master controller in response to the detection of motion within one of the plurality the regions of interest; and
wherein the master controller is configured to activate at least one of the plurality of RFID exciters in response to receipt of a trigger message from the application server.

18. The RFID system of claim 17, wherein:
the master controller is configured to store information associating RFID exciters with regions of interest;
the application server is configured to send trigger messages that identify the region of interest in which motion was detected; and
the master controller is configured to activate RFID exciters associated with a region of interest identified in a trigger message.

19. The RFID system of claim 17, wherein:
the application server is configured to store information associating RFID exciters with regions of interest;
the application server is configured to send trigger messages that identify the RFID exciters associated with the region of interest in which motion was detected; and
the master controller is configured to activate the RFID exciters identified in a trigger message received from the application server.

20. The RFID receiver system of claim 17, wherein the master controller is configured to estimate the location of an RFID tag based upon observations of RFID tag reads in response to activation of a plurality of the RFID exciters over time and the detection of motion within regions of interest.

21. The RFID receiver system of claim 17, wherein:
the video camera is one of a plurality of video cameras connected to the application server;
each video camera is configured to provide a video sequence of a scene to the application server;
the application server is configured to store information concerning a plurality of regions of interest within the plurality of scenes provided by the video cameras;
the application server is configured to detect motion within any of the plurality of regions of interest using the video sequence;
the application server is configured to send a trigger message to the master controller in response to the detection of motion within one of the plurality the regions of interest; and
the master controller is configured to activate at least one of the plurality of RFID exciters in response to receipt of a trigger message from the application server.

22. An RFID receiver system, comprising:
an RFID exciter configured to communicate with a master controller, where the master controller is configured to control activation of the RFID exciter;
a video camera connected to an application server, where the application server is configured to communicate with the master controller; and
a display configured to communicate with the application server;
wherein the video camera is configured to provide a video sequence of a scene to the application server;
wherein the master controller is configured to estimate the location of an RFID tag based upon at least the signals backscattered by the RFID tag in response to the activation of the RFID exciter;
wherein the application server is configured to render an overlay including a visual indicator in the estimated location of the RFID tag; and
wherein the application server is configured to combine the overlay and the video sequence of the scene for viewing via the display.

23. The RFID system of claim 22, wherein rendering an overlay including a visual indicator in the estimated location of the RFID tag further comprises:
mapping the estimated location to pixel positions within the scene; and
inserting a visual indicator in the pixel positions corresponding to the estimated location.

24. The RFID system of claim 23, wherein mapping the estimated location to positions within the scene, comprises applying at least one transformation to the estimated location to account for warping introduced into the scene by the camera.

25. The RFID system of claim 24, wherein the at least one transformation includes transforming the estimated location to account for barrel distortion introduced into the scene by the camera.

26. The RFID system of claim 24, wherein the at least one transformation includes transforming the estimated location to account for perspective distortion introduced into the scene by the camera.

27. A method of activating an RFID exciter, comprising:
defining a region of interest within a scene captured by a video camera;
monitoring a video sequence captured by the video camera to detect motion within the region of interest; and
triggering the activation of an RFID exciter associated with the region of interest in response to the detection of motion within the region of interest.

28. The method of claim 27, further comprising:
defining a destination point within the scene captured by the video camera, where the destination point is associated with the region of interest; and
determining whether the detected motion within the region of interest is toward the destination point;
wherein the RFID exciter is activated in response to the detection of motion toward the destination point within the region of interest.

29. The method of claim 28, further comprising:
determining whether the detected motion within the region of interest is away from the destination point;
wherein the RFID exciter is activated in response to the detection of motion away from the destination point within the region of interest.

30. The method of claim 27, further comprising:
determining the size of the object moving within the region of interest;
wherein the RFID exciter is activated in response to the detection of motion associated with an object having a size exceeding a predetermined threshold within the region of interest.

31. The method of claim 27, further comprising:
determining the magnitude of the detected motion in multiple successive frames of the video sequence;
wherein the RFID exciter is activated in response to the detection of similar motion within the region of interest in multiple successive frames of the video sequence.

32. A method of displaying the location of an object bearing an RFID tag, comprising:
estimating the location of the RFID tag using an RFID receiver system;
capturing a video sequence of a scene including the object bearing the RFID tag using a video camera;
generating an overlay including a visual indication of the location of the RFID tag using the estimated location of the RFID tag provided by the RFID receiver system; and
displaying the combined overlay and video sequence.
